(19) United States
(12) Patent Application Publication
(10) Pub. No.: US 2018/0232778 A1
(43) Pub. Date: Aug. 16, 2018

(54) CLOTHING STORE FITTING ROOM RETARGETING SYSTEM AND METHOD

(71) Applicant: TechStyle, Inc., El Segundo, CA (US)

(72) Inventors: Dustin Netral, Redondo Beach, CA (US); Gregg William Throgmartin, Manhattan Beach, CA (US); Kevin Matthew McVey, Floyd Knobs, IN (US); Melanie Nicole Cummings, Wilmington, CA (US); Brian Robert Leibreich, Amelia, OH (US); John Blayter, Castle Rock, CO (US); David Benjamin Brooks, Denver, CO (US); Anthony Fox, Sharon, PA (US)

(21) Appl. No.: 15/433,869

(22) Filed: Feb. 15, 2017

(51) Int. Cl. G06Q 30/02; G06Q 10/08; G06Q 20/20; G06Q 30/06

(52) U.S. Cl. CPC G06Q 30/0271; G06Q 10/087; G06Q 20/203; G06Q 30/0254; G06Q 30/0255; G06Q 30/0267; G06Q 30/0269; G06Q 30/0601; G06Q 30/0631; G06Q 30/0641; G06Q 20/20; G06Q 30/0251; G06Q 30/0268

(57) ABSTRACT

A system and method utilizing store fitting room information to develop targeted advertising and offers directed to customers whose information has been collected at least in part in the fitting room.

### BACKGROUND OF THE INVENTION

### Incorporation by Reference

This application incorporates by reference, in their entireties and for all purposes, the following patent documents: U.S. Pat. No. 9,330,413 to Agarwal et al, U.S. Pat. No. 5,960,411 to Hartman et al., U.S. Pat. No. 6,026,375 to Hall et al., U.S. Pat. No. 6,880,750 B2 to Pentel, and U.S. Pat. No. 8,200,550 B2 to Altkins.

### Field of the Invention

The present invention relates to systems and methods for selecting and targeting advertising. In particular, a system includes facilities for acquiring data, analyzing data, and selecting responsive advertising.

### Discussion of the Related Art

Internet based advertising and especially internet services unrelated to, but nevertheless funded by, advertising dollars are well known. Typical of these services are search engines that present users with advertisements before search results are revealed or alongside search results. For example, a Google® search on the term “clothing” may show in a somewhat columnar format hits in a page left column and ads in a page right column. In some cases the ads may be related to the search term and, as such, be referred to as “targeted” ads. Here, it is the entry of a search term that provides the information used to select or target a product advertisement.

### SUMMARY OF THE INVENTION

The present invention provides a clothing store fitting room retargeting system and method. In an embodiment, a clothing store fitting room retargeting system comprises: a clothing store stocked with diverse tagged merchandise items; the store manned by associates and including areas where customers may handle the items; a cart with a unique cart identifier and a customer's item(s) placed in the cart; cart notes recorded in a database, the notes including a cart list identifying the item(s) in the cart and the database including a link that associates the customer with each item; the cart moved to a fitting room and fitting room notes recorded in the database, the fitting room notes including (i) a list of one or more items dropped from the cart and (ii) a list of one or more items added to the cart; and, the cart processed with an in-store point-of-sale device wherein point of sale data is stored by item in the database.

In some embodiments, for a plurality of carts, a database query that identifies customers that left the store without purchasing all of the items placed in the customer's cart; and, for a customer that left the store without purchasing all of the items placed in the customer's cart, construction of an offer of sale of the items not purchased and delivery of the offer to the customer via electronic means. And, in some embodiments, for a customer that dropped items from a cart, construction of a targeted offer of sale of items that are complementary to one or more of the dropped items.

### BRIEF DESCRIPTION OF THE DRAWINGS

The present invention is described with reference to the accompanying figures. These figures, incorporated herein and forming part of the specification, illustrate the invention and, together with the description, further serve to explain its principles enabling a person skilled in the relevant art to make and use the invention.

FIG. 1 shows a clothing store with a fitting room of the present invention.

FIG. 2A shows an expanded view of the fitting room of FIG. 1

FIG. 2B shows an exemplary fitting room activity flow chart used in connection with the fitting room of FIG. 1.

FIG. 2C shows an exemplary database for use with selected embodiments of the fitting room of FIG. 1.

FIG. 2D shows fitting room and fitting room related information used for retargeting offers.

FIGS. 3A-D show a process related to a fitting room.

FIGS. 4A-C show process scenarios related to a fitting room.

### DETAILED DESCRIPTION OF THE PREFERRED EMBODIMENTS

The disclosure provided in the following pages describes examples of some embodiments of the invention. The designs, figures, and description are non-limiting examples of embodiments they disclose. For example, other embodiments of the disclosed device and/or method may or may not include the features described herein. Moreover, disclosed advantages and benefits may apply to only certain embodiments of the invention and should not be used to limit the disclosed invention.

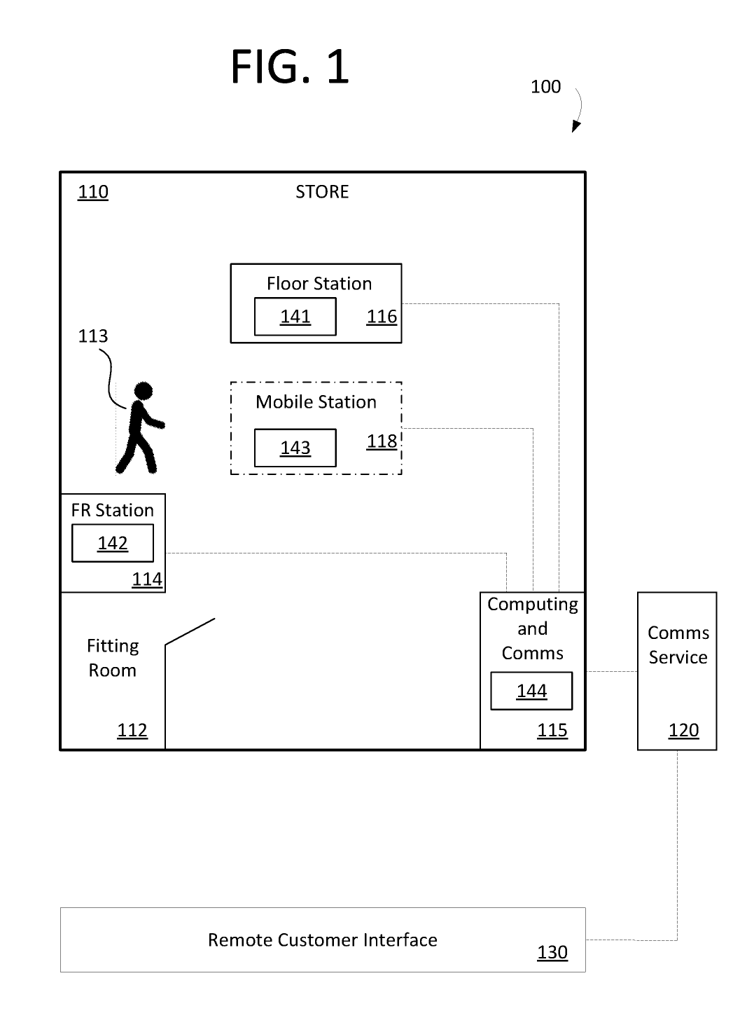

FIG. 1 shows a clothing store with a fitting room (“FR”) 100. The clothing store 110 fitting room 112 is associated with a fitting room station 114 which may be attended by a store associate 113 such as an associate carrying a mobile station or device 118. In various embodiments, a floor station 116 includes a point of sale device (“POS”) 141 and a mobile device 118 includes a POS 143. And, in some embodiments, the fitting room station 114 may include a POS 142.

A store computing and communications (“comms”) network 115 interconnects with each of the points of sale. The floor station POS 141 and fitting room POS 142 may interconnect with physical media such as copper or fiber media. The mobile station interconnects via a wireless protocol. Communications media and protocols suited to the application include wired media, wireless media, any 802.x IEEE wireless communications standard, and custom protocols.

In an embodiment, the mobile station 118 includes a wireless 802.x WiFi device as does the network 115. In various embodiments the network 115 includes a gateway such as an Internet connected gateway via a communications service 120 such as an internet service provider (“ISP”).

A typical network 115 includes one or more microprocessors, semiconductor memory, a mass storage device, and communications facilities such as Ethernet communications for interconnecting point of sale devices. The network may include a man machine interface with any of a display screen, keyboard, and mouse. Other interfaces may provide additional input and output devices such as for card readers, bar code readers, and magnetic strip readers.

The network 115 may be distributed or not, distributed within the store 110, and distributed within the store and beyond, for example with other stores. Further, the network may include a point of sale device 144 accessible via the gateway and the Internet. For example, store customers may use the network POS to place orders from outside the store and persons in the store may use the network POS to place orders from within the store.

Access to the store may be by physical presence in the store 110 or via virtual access to store merchandise. Virtual access may be provided by a customer remote interface 130 used to browse a store web site or run a store app. The remote interface includes a customer operated computing device such as any of a computer, tablet, cell phone, or the like.

As used herein, a point of sale device refers to computer or computer related hardware capable of recognizing, with or without human assistance, an identifier such as an item number that is associated with an item of store merchandise. For example, an item number or bar code may be read from a tag, a magnetic strip or bar code. For example, an item number may be printed on a tag and input into the POS by an associate. For example, an item number may associated with an on screen display of an item and selectable via a mouse click, number entry, or similar action by an associate or customer. In some embodiments, the POS provides for entry of information relating to a customer transaction and/or a customer experience.

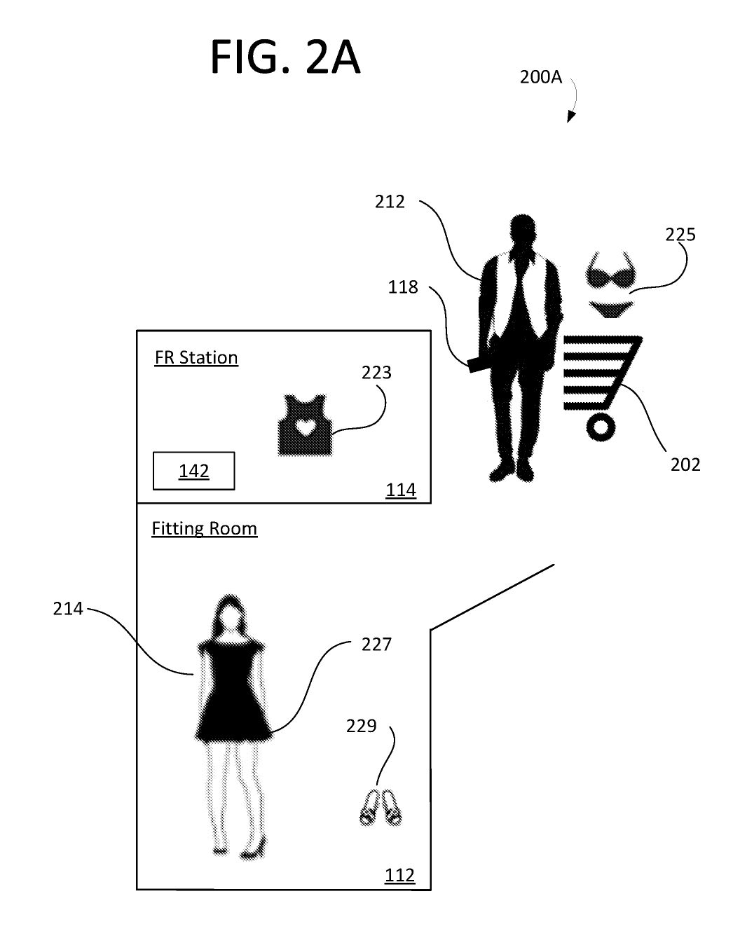

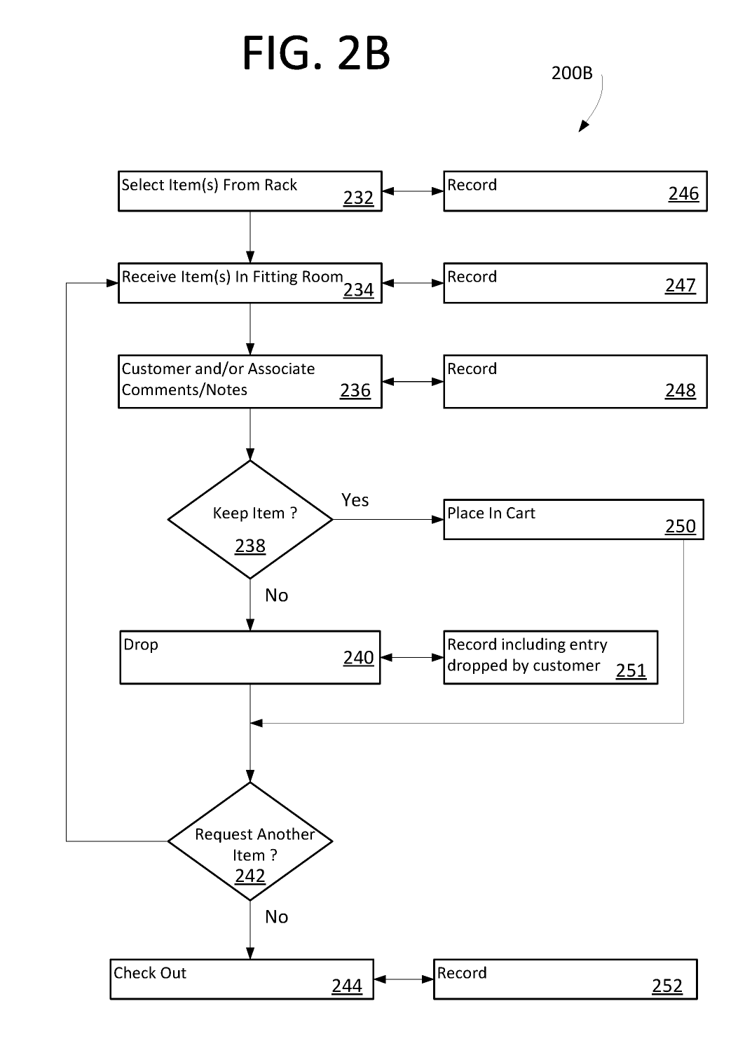

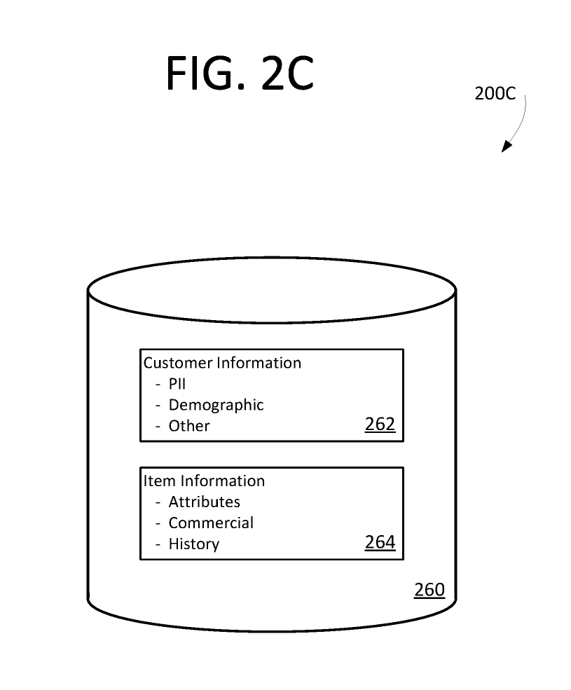

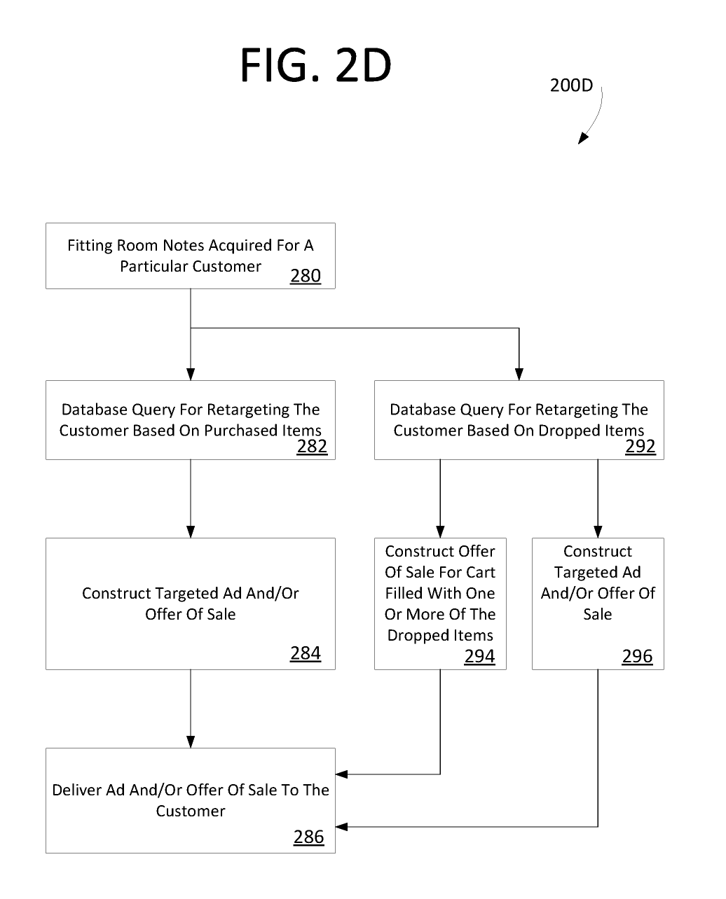

FIG. 2A shows an expanded view of a fitting room in use 200A. As seen, a customer 214 is in the fitting room 112 with items of merchandise including a first item (e.g., dress) 227 and/or a second item (e.g., shoes) 229.

Outside the fitting room 112 a cart 202 holds an item 225 (e.g. bathing suit) that the customer has selected for purchase. At the fitting room station 114 an item 223 (e.g., blouse) the customer has determined not to purchase (e.g., deselected or dumped) awaits return to a store rack.

In some embodiments, a store associate 212 assists the customer 214. For example, a store associate may answer a customer's call or may be standing at the ready to assist a customer. Via a remote device 118 or a fitting room station POS device 142 the associate is equipped to enter information about the customer, information about the items, and/or customer comments.

FIG. 2B shows an exemplary fitting room activity flow chart 200B. In a first step 232, a customer selects store merchandise item(s). Information concerning the customer, customer comments, associate comments, and the items (“notes”) may be recorded contemporaneously with the first step or not 246.

Notes may include customer identifying information, customer comments, associate comments, item attributes including one or more of cart, cart identification, item number, style, size, fit, color, manufacturer, location (e.g., store), and the like, and/or associating any of the above. For example, the notes recorded and the notes or database data structure, such as key field(s) and linked key field(s), may provide for queries on either of i) customer identifying information or ii) item attribute(s) that are useful for recalling the other.

Notes recording may be by the associate 212 using a POS or a mobile device 118, tag reader (e.g., magnetic, optical), or video camera. Notes recording may be by the customer 214 using any of the above, a customer or store device, or by autonomous devices such as RFID tags/readers and/or video camera recognition. And, notes recording may include recording the same in any of the databases mentioned below.

In the fitting room, the customer models and/or otherwise considers one or more items during a second step 234. In the second step, notes may be available and recorded contemporaneously or not 247. In a third step 236 following customer consideration of an item(s), notes may be available and recorded contemporaneously or not 248.

Having decided whether to keep the item or not in a fourth step 238, the item is either placed in a cart 250 for purchase or it is returned or dropped in a fifth step 240. In the fifth step, notes may be available and recorded contemporaneously or not 251. To the extent a customer drops item(s) in the fifth step, the dropped item(s) are recorded in notes as dropped by the customer.

After disposition of the item, the customer may request another item 242 or proceed to check out in a seventh step 244. If another item is requested, in the sixth step 242, the process returns to the second step 234. If not, check out may occur contemporaneously or not with a recording of notes including transaction information 252 including a list of the items purchased.

As skilled artisans will appreciate, recording information about the customer, customer experience, transaction, and items may take place at all of the steps of the flowchart of FIG. 2B or may take place at selected ones of the steps as discussed above. Whatever the case, information about items considered, items declined, and items purchased may be captured along with customer information, contemporaneous customer comments, associate comments, associate checklist information, and other recordable information.

FIG. 2C shows an exemplary database for use with selected embodiments of the present invention 200C. As shown, the database includes customer information 262 and item information 264. The database may be one or multiple databases stored by or in communication with the network 115.

Customer information 262 may include selected portions of the customer's personally identifiable information (“PII”), demographic information, and other information useful for financial transactions, customer service, and customer assessment. Sources of customer information include the customer, commercial credit report services, social media, and customer contacts.

Item information 264 may include item attributes, item commercial information such as price and inventory, and item history. Sources of item information include vendor provided data, store and warehouse data, and fitting room/other data 246, 247, 278, 251, 252.

As a consequence of the above, any item in a store 110 that passes through a store fitting room 114 may contribute to the item history. For example, customer likes and dislikes about the item's style, sizing, color(s), fit, material or fabric quality, construction quality, and fashion may be the subject of notes recorded in the item history database entry.

FIG. 2D shows fitting room and fitting room related information used for retargeting offers 200D.

In a First Scenario: In a first step 280, fitting room notes are acquired for a particular customer, for example during a visit to a store 110 and during use of a fitting room 112 therein.

In a second step 282, the database 260 is queried for retargeting the customer based on information about the items previously purchased 282. Using this information, a targeted advertisement or offer of sale is constructed in a third step 284. In a fourth step 286, this advertisement or offer of sale is delivered to a customer as by a remote customer interface 130 such as a computer or cell phone.

In a Second Scenario: In a first step 280, fitting room notes are acquired for a particular customer, for example during a visit to a store 110 and during use of a fitting room 112 therein.

In a second step 292, the database 260 is queried for retargeting the customer based on information about the items previously dropped. Using this information, a targeted offer of sale via a cart filled with one or more of the dropped items is constructed in a third step 294. In a fourth step 286, this advertisement or offer of sale is delivered to a customer as by a remote customer interface 130 such as a computer or cell phone.

In a Third Scenario: In a first step 280, fitting room notes are acquired for a particular customer, for example during a visit to a store 110 and during use of a fitting room 112 therein.

In a second step 292, the database 260 is queried for retargeting the customer based on information about the items previously dropped 292. Using this information, an advertisement or targeted offer of sale is constructed in a third step 296. In a fourth step 286, this advertisement or offer of sale is delivered to a customer as by a remote customer interface 130 such as a computer or cell phone.

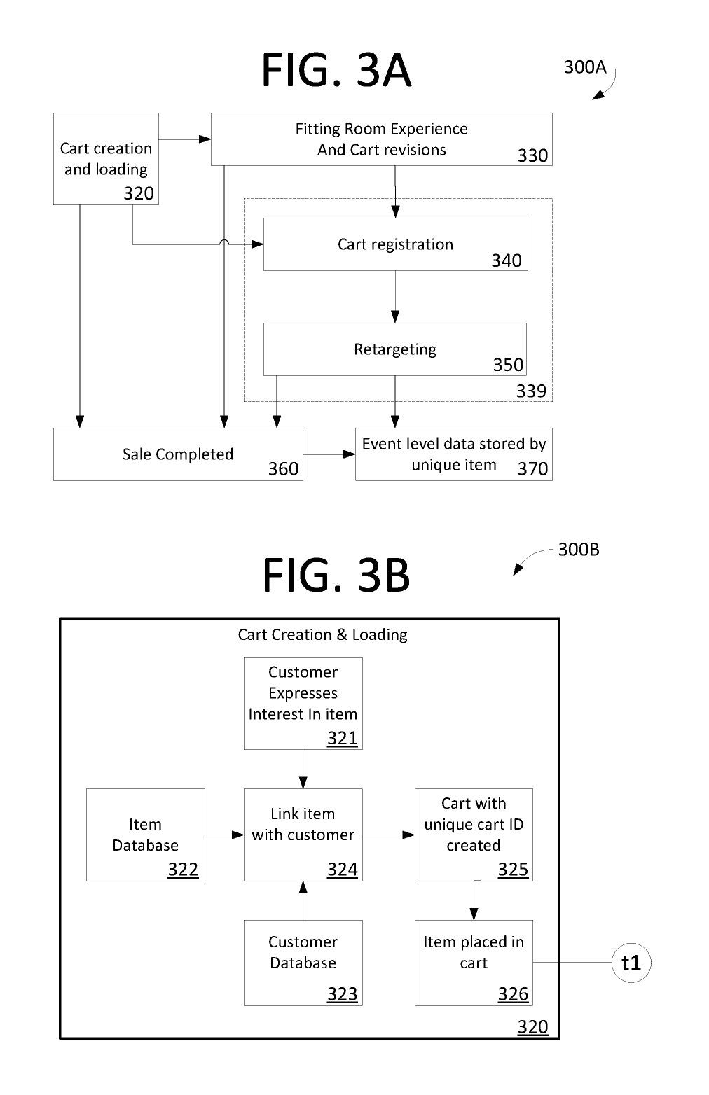

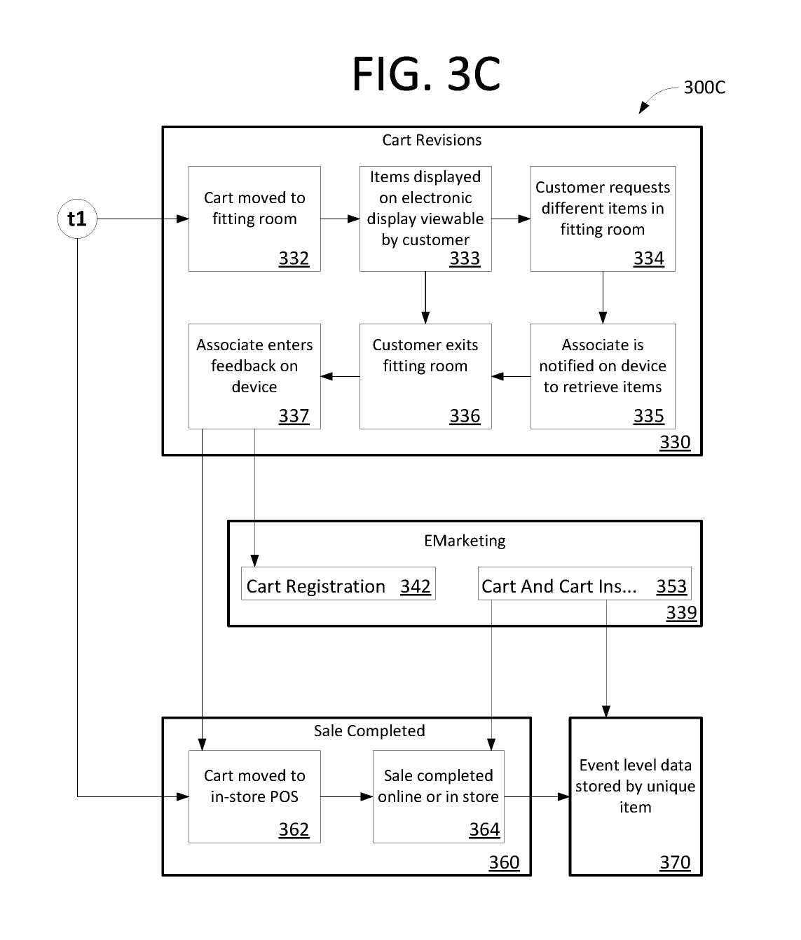

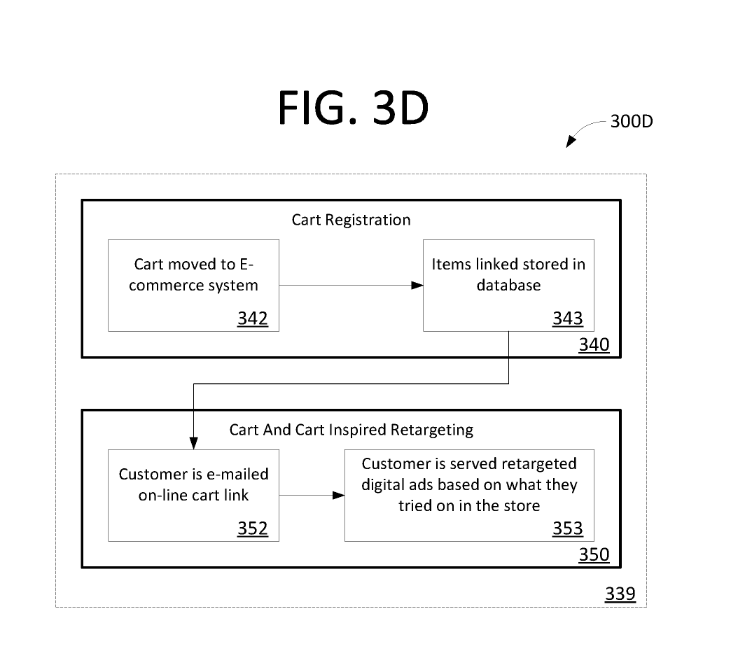

FIGS. 3A-D shows a fitting room and fitting room related process 300A-D.

In FIG. 3A, process elements include cart 202 creation and loading 320, fitting room experience and cart revisions 330, electronic commerce 339, sale completion 360, and event level data storage by unique item 370. The electronic commerce element 339 includes one or both of cart registration 340 and retargeting 350. For any of these elements or steps within, notes may be recorded in the database 260 as discussed above.

As shown, cart creation and loading 320 may precede any of fitting room experience and cart revisions 330, cart registration 340, and sale completed 360. Fitting room experience and cart revisions 330 may precede sale completed 360. Fitting room experience and cart revisions 330 may precede cart registration 340 which may precede retargeting 350. Retargeting 350 may precede sale completed 360 and event level data storage by unique item 370 which may be preceded by sale completed 360.

FIG. 3B shows steps within the cart creation and loading element 320. Steps include linking an item(s) with a customer 324 which is preceded by one or more of a customer expressed interest in item step 321, an item database step 322, and a customer database step 323. As will be appreciated by skilled artisans, for a particular item 321, item attributes may be read from the item database 322 and in similar fashion customer attributes may be read from the customer database 323. In step 324, the item may be linked with a customer 214 and this linkage may be recorded and/or recorded as a note in the database 260.

Cart creation with a unique cart ID 325 follows the link item with customer step 324. Cart creation is followed by item(s) the customer expresses interest in being placed in the cart 326.

FIG. 3C shows steps within the fitting room experience and cart revisions element 330. Here, an item is displayed on electronic display viewable by customer step 333 is preceded by a cart moved to fitting room step 332 and succeeded by a customer exits the fitting room step 336. Alternatively, step 333 may reach step 336 by passing through a customer requests different items in the fitting room step 334 and an associate is notified on a device such as a mobile device 118 to retrieve items step 335. Step 336 is followed by an associate enters feedback and/or notes on a device such as a mobile device 118 in step 337.

In addition, FIG. 3C shows sub-elements within the electronic commerce element 339. Sub-elements include cart registration 340 and cart and cart inspired retargeting 350. The cart registration step 340 may be reached from the associate enters feedback on device step 337. The cart and cart inspired retargeting step 350 may be reached from the cart registration step 340.

Further, FIG. 3C shows steps within the sale completed element 360 followed by the event level data storage by unique item element 370. In the sale completed element 360 a cart may be moved to an in-store POS step 362 followed by a sale completed in-store step 364 and the event level data storage by unique item element 370. The cart moved to in-store POS step 362 may be reached from the item placed in cart step 326 or from the associate enters notes/feedback on device step 337. Alternatively, the cart and cart inspired retargeting step 350 may precede either of the sale completed online or in store step 364 or the event level data stored by unique item step 370.

FIG. 3D shows sub-elements within the electronic commerce element 339. Sub-elements include cart registration 340 and cart and cart inspired retargeting 350. Within the cart registration sub-element 340, a cart moved to E-commerce system step 342 precedes an items linked stored in database 260 step 343. Within the cart and cart inspired retargeting sub-element 350, step 352 wherein a customer is e-mailed an on-line cart link, is preceded by step 343 and followed by a step 353 wherein the customer is served retargeted digital ads/offers on items purchased or dropped and/or on items related to (e.g., similar or complementary) items purchased or dropped.

Database queries may be used to identify one or more customers based on a status or state of the cart and/or how the state of the cart changed over time. For example, for a plurality of carts, a database query may identify customers 214 that left the store 110 without purchasing all of the items placed in the customer's cart. And, for example, for a customer that dropped items from a cart, construction of a targeted offer of sale of items that are complementary to one or more of the dropped items.

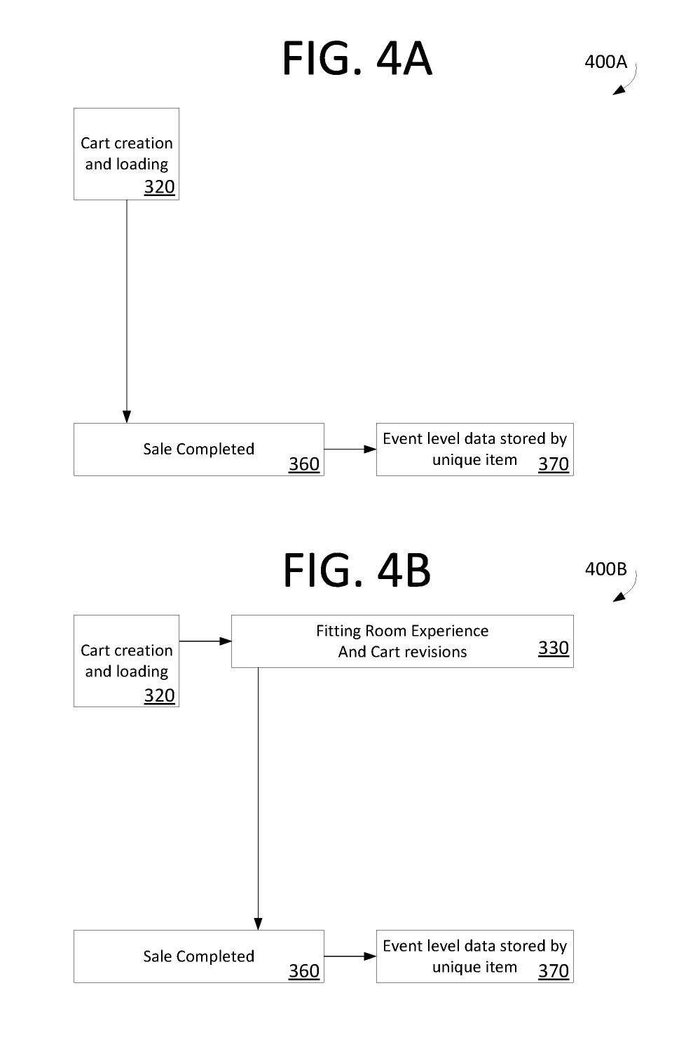

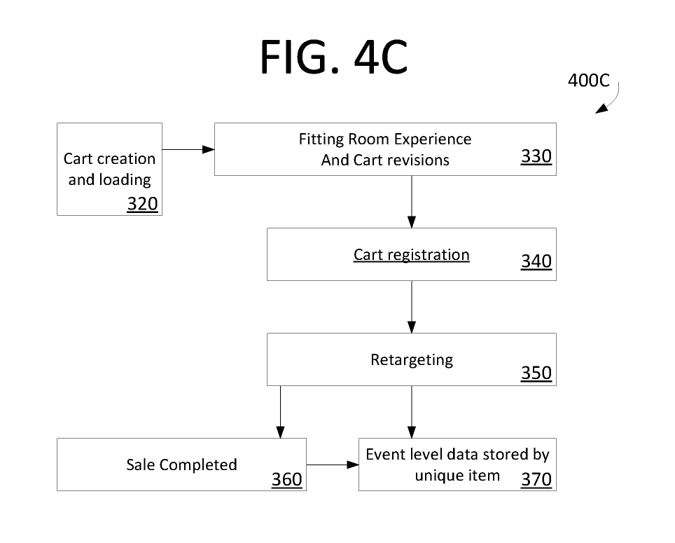

FIGS. 4A-C show fitting room and fitting room related process scenarios 400A-C.

In FIG. 4A, a fitting room and fitting room related process includes three elements. In particular, a sale completed element 360 is preceded by a cart creating and loading element 320 and followed by database storage (e.g., database 260) of event level data by unique item in element 370.

In an example, a customer 214 enters a fitting room 112 in a store 110. The customer expresses interest in an item 321 and a store associate links the item with the customer in a database 260 using a mobile device 118. A cart with a unique cart ID is created 325 and the item is placed in the cart, virtual or not 326. The cart is moved to an in-store POS 362, the sale is completed 364, and event level data is stored by unique item 370 in a database 260.

In FIG. 4B, a fitting room and fitting room related process includes four elements. In particular, a sale completed element 360 is preceded by a fitting room experience and cart revisions element 330 which is preceded by a cart creation and loading element 320. Following the sale completed element 360 is a database storage (e.g., database 260) of event level data by unique item element 370.

In an example, a customer 214 enters a fitting room 112 in a store 110. The customer expresses interest in an item 321 and a store associate links the item with the customer in a database 260 using a mobile device 118. A cart with a unique cart ID is created 325 and the item is placed in the cart, virtual or not 326. During cart revisions, 330, the cart is moved to a fitting room 332 and one or more of i) item display on an electronic display 333, ii) customer requests for different items 334, and associate retrieval of requested item(s) occur. Fitting room notes are recorded before or after the customer exits the fitting room 336. The revised cart is moved to an in-store POS 362, the sale is completed 364, and event level data is stored by unique item 370 in a database 260.

In FIG. 4C, a cart registration sub-element 340 is preceded by a fitting room experience and cart revisions element 330 which is preceded by a cart creation and loading element 320. Sub-element 340 may be followed by a retargeting sub-element 350 that may be followed by database storage (e.g., database 260) of event level data by unique item element 370. Further, retargeting sub-element 350 may be followed by a sale completed element 360 that may be followed by database storage (e.g., database 260) of event level data by unique item element 370.

In an example, a customer 214 enters a fitting room 112 in a store 110. The customer expresses interest in an item 321 and a store associate links the item with the customer in a database 260 using a mobile device 118. A cart with a unique cart ID is created 325 and the item is placed in the cart, virtual or not 326. During cart revisions, 330, the cart is moved to a fitting room 332 and one or more of i) item display on an electronic display 333, ii) customer requests for different items 334, and associate retrieval of requested item(s) occur. Fitting room notes are recorded before or after the customer exits the fitting room 336. Cart registration 340 follows with the cart being moved to an electronic commerce system 342 and the database 260 being loaded or updated with notes 343. Cart registration is followed by cart and cart inspired retargeting 339. Here, the customer is contacted electronically (e.g., email, social media, targeted electronic ads, targeted electronic offers) 352 and may receive targeted ads, targeted offers, and/or an opportunity to purchase dropped items 353. The revised cart is moved to an in-store POS 362, the sale is completed 364, and event level data is stored by unique item 370 in a database 260.

While various embodiments of the present invention have been described above, it should be understood that they have been presented by way of example only, and not limitation. It will be apparent to those skilled in the art that various changes in the form and details can be made without departing from the spirit and scope of the invention. As such, the breadth and scope of the present invention should not be limited by the above-described exemplary embodiments, but should be defined only in accordance with the following claims and equivalents thereof.

What is claimed is:

1. A clothing store fitting room retargeting system comprising:
a clothing store stocked with diverse tagged merchandise items;
the store manned by associates and including areas where customers may handle the items;
a cart with a unique cart identifier and a customer's item(s) placed in the cart;
cart notes recorded in a database, the notes including a cart list identifying the item(s) in the cart and the database including a link that associates the customer with each item;
the cart moved to a fitting room after which fitting room notes are recorded in the database, the fitting room notes including (i) a list of one or more items dropped from the cart and (ii) a list of items added to the cart; and,
the cart processed with an in-store point-of-sale device wherein point of sale data is stored by item in the database.

2. The system of claim 1 further comprising:
for a plurality of carts, a database query identifies customers that left the store without purchasing all of the items placed in the customer's cart; and,
for a customer that left the store without purchasing all of the items placed in the customer's cart, construction of an offer of sale of the items not purchased and delivery of the offer to the customer via electronic means.

3. The system of claim 2 further comprising:
for a customer that purchased items from a cart, construction of a targeted offer of sale of items that are complementary to one or more of the purchased items.

4. A merchant method of retargeting a customer who handled but failed to purchase one or more items of clothing, the method comprising the steps of:
in a clothing store with a fitting room, providing a physical shopping cart and customer selected items therein;
in a database, recording the items in the shopping cart and associating customer identifying indicia with each of the items;
at the fitting room, attending the customer by i) adding one or more items to the shopping cart and ii) removing one or more items from the shopping cart;
in the database, recording the items added, recording the items removed, and associating the customer with each of the items;
creating a virtual shopping cart containing indicia of the items removed from the physical shopping cart; and,
after the customer leaves the store, presenting the customer with an offer of sale of the items in the virtual shopping cart via an electronic document transmitted to a customer operated remote device.
